(19) United States
(12) Patent Application Publication
(10) Pub. No.: US 2010/0052907 A1
(43) Pub. Date: Mar. 4, 2010

(54) Bicycle or other mobile object anti-theft alarm device

(76) Inventors: John Alfred Shannon, Tucson, AZ (US); Debra Carliss Shannon, Tucson, AZ (US); Devendra Girish Soman, Satara (IN)

Correspondence Address: John and Debra Shannon, P.O. Box 57147, Tucson, AZ, 85732, US

(21) Appl. No.: 12/380,271

(22) Filed: Feb. 24, 2009

Related U.S. Application Data
(60) Provisional application No. 61/032,844, filed on Feb. 29, 2008.

(51) Int. Cl. G08B 13/14

(52) U.S. Cl. 340/568.6; 340/692

(57) ABSTRACT

A security alarm system suitable for bicycles or other mobile articles, which may be attached to said article to be protected. This anti-theft device is equipped with a security cable and a siren and two LED's. Said cable may be spooled thru the major components of the article. Having several options of attachment said alarm is suitable on many different articles, such as construction equipment, motorcycles, children's toys, barbeques etcetera. The security siren alarm system is simple to operate yet provides a sophisticated security unit. This system uses a low current drain design in the arming/timing circuit to provide long battery life. The security cable provides ample length to attach a number of parts together even more than one bicycle. Should this cable be cut or somehow removed the attached alarm will sound off for up to three hours. Thus providing ample time to thwart or apprehended the thief

The invention is a bicycle or other mobile object anti-theft security and alarm system.

This application claims priority to provisional patent No. 61/032,844 dated Feb. 29, 2008.

The invention relates to a alarm and locking device physically attached to the unit to be protected.

This device may be attached to the object to be protected in several ways:

To a tubular bicycle fame using blind clamps around a frame member with said clamp secured to the housing from inside of the locking removable cover.

Mounting directly from inside of the locking removable cover to a set of water bottle rack mounting bosses furnished on most bicycles by the manufacturer.

Mounting on a surface such as a cowling or fender of a scooter of other flat surface by using either blind or security screws and an insert or nut and washers inside of the locking removable cover.

Having several options of attachment said alarm is suitable to be used on many different articles, such as Yard or construction equipment, motorcycles, scooters, large children's toys, grills, barbeque pits, etcetera.

The alarm system contains a spool in the casing to house a security cable when the alarm is not in use. This spool contains in its core a spring motor to retrieve the security cable after being released by the locking port and not in use. This cable should be of adequate length any reasonable size depending on the dynamics of the casing and spooling assembly, as long as it is flexible stainless steel or flexible hardened wire rope with a Teflon or plastic coating that will act as both an insulator and an anti chafing device.

When the device is to be used the security cable is withdrawn from the casing and spooled through the units major components such as wheels, saddle, sprocket, basket, etcetera. Then around or through a stationary object. Said security cable is equipped with a locking pin at the free end of said security cable which is then plugged in the locking port and the system is armed with the high security arming key. When the key is turned after the locking pin is inserted, the locking cam engages the recess in the locking pin and in doing so makes electrical connection with same and at the same time trips the arming switch and the system is armed.

When the unit is activated by the arming switch, battery power is supplied to the circuit board activating the timer for the warning light emitting diodes and supplying bias the base of Q1 a switching transistor, which is pulled down to zero potential by the security cable connection. Should this security cable connection be broken the base of Q1 will go to a positive potential supplying power to the siren sonic alarm producing 100+ decibels of siren alert, audible at least 300 feet (10M) above a 70 decibel average ambient noise. At this time the warning light emitting diodes go to full on and full brightness. This condition will last for up to three hours depending on the age of the batteries, or until the high security key is used to disarm the system.

When the system is disarmed by the rotary security lock assembly; the locking pin is released and the spring motor inside the reel will re-spool the security cable to its storage position inside the housing, and the warning light emitting diodes are turned off.

This system by use of several means to secure the object to be protected against tampering and theft; A loud siren alarm, the visual presence of the warning, light emitting diodes constant blinking when the system is armed, an obvious cable presence plus the security of the strong cable also the secure attachment of the system itself to the unit to be protected.

The afore mentioned amenities will provide a strong deterrent against tampering and theft.

### DWG. LIST

One embodiment of this alarm system is herein described by way of example, with reference to the accompanying drawings.

FIG. 1 A view of the invention with the removable locking cover removed.

FIG. 1a A view of the security cable with the locking pin and securing eyelet.

FIG. 2 A backside view of the alarm system showing the key port, locking pin port, and speaker outlet.

FIG. 3 A straight on view of the service side of the alarm system showing the internal operating components

FIG. 4 A schematic drawing showing the circuit for the arming and alarm functions.

FIG. 5 A inside view of the locking service cover with locking spring and mounting scheme.

### DRAWING REFERENCE

Referring to the drawings, the embodiment of the invention comprises of a casing [FIG. 1](5), containing a spool assembly (10)(11), carrying a vinyl or Teflon insulated steel cable assembly or security cable [FIG. 1a](18)(19)(20). Said cable is carried at circuit ground potential when the system is armed. Said security cable is housed on a spool (10) when not in use, said cable has one end attached to the spool containing a retrieval motor (11). Said spooling assembly is held in place by the permanent spool cover (1) secured to the housing by tabs and screws accessible only when the system is open for maintenance. Said cables home port (9) holds the locking pin (18) at the free end of said cable when the system is not in use. Said cable spool assembly contains a core spindle (12) that also provides an electrical connection from the cable assembly to the arming circuit board (7). Said circuit board drives the sonic siren driver (8) and speaker (3) assembly when the system is in alarm mode.

The batteries (4) are also located in said casing (5). Said batteries are two 9 Volt conforming to (ANSI standard 1604A) with snap on connectors.

The back side of the casing [FIG. 2] shows the high security rotary lock (16) key port, said security cable locking pin port (9) and said speaker port (14).

Said arming switch shown in [FIG. 3] (17) is activated by the locking cam (6). When the cam-lock assembly (6) (16) is in the armed position said switch (17) is activates and the cam (6) will captivate said locking pin (18) making electrical contact with said cable assembly [FIG. 1a] holding the system in alert. Should this connection be broken or said locking pin (18) not be inserted in said locking pin port (9) said alarm will sound.

Said afore mentioned locking removable cover [FIG. 5] slides onto the narrow end of said housing (5) and is captivated by a taper and lip, when in place a spring latch (22) mounted to the cover (23)(24) snaps into position locking said cover (21) in place. When access is required said cam-lock assembly (6) (16) is placed in the service position bringing the vertical portion of the cam (6) into position under the spring latch (22) depressing said spring latch (22) allowing the cover (21) to be removed.

FIG. 1 and FIG. 2 also show a clamping attachment system (2) said system being constructed in such a way as to have the mounting hardware only accessible from inside the lockable removable cover (21) shown in [FIG. 5]. Also shown in these illustrations is a tubular representation of a piece of bicycle frame (15) used only as a prop for the assembly drawings.

FIG. 3 shows an alternative mounting solution (13) the system will mount directly to standard water bottle accessory mounts supplied on most modern bicycles by the manufacturer. This solution is also accessible only from the inside the lockable removable cover (21) shown in [FIG. 5]. This mounting solution also allows the unit to be mounted to a flat surface with security screws from the outside and an insert or nut and washer hardware on the inside, allowing it to be used for a number of other applications such as motor scooters, lawn tractors, etc.

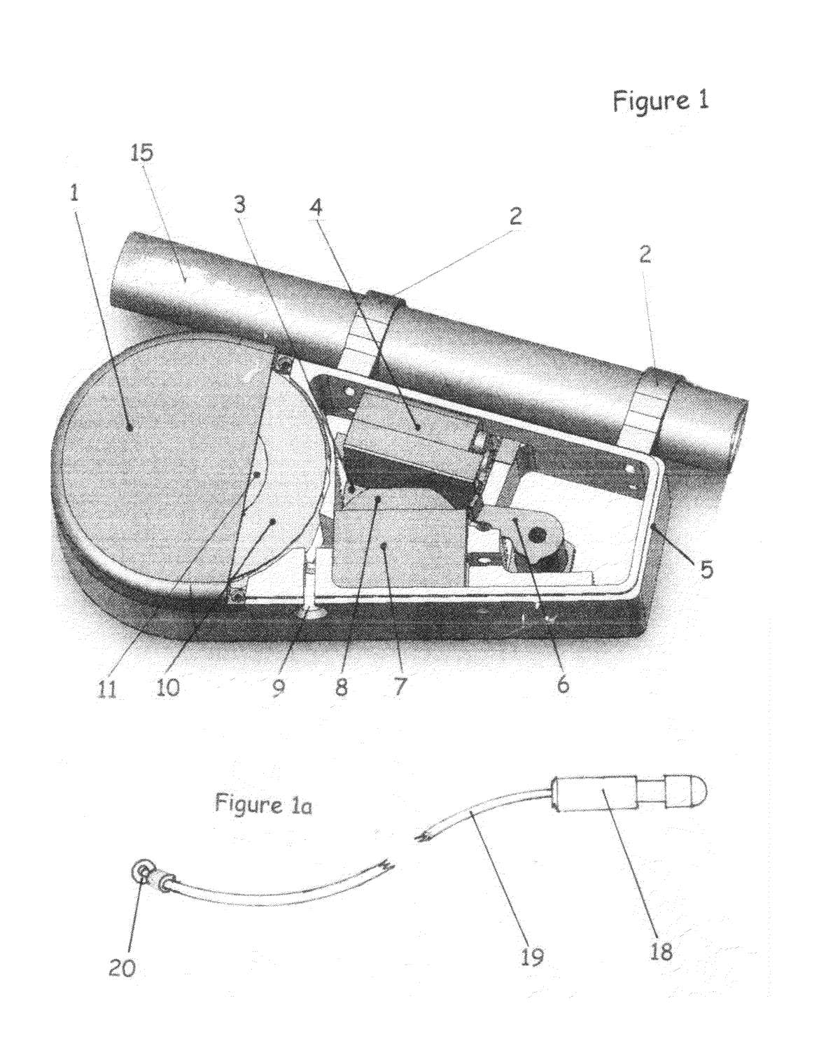

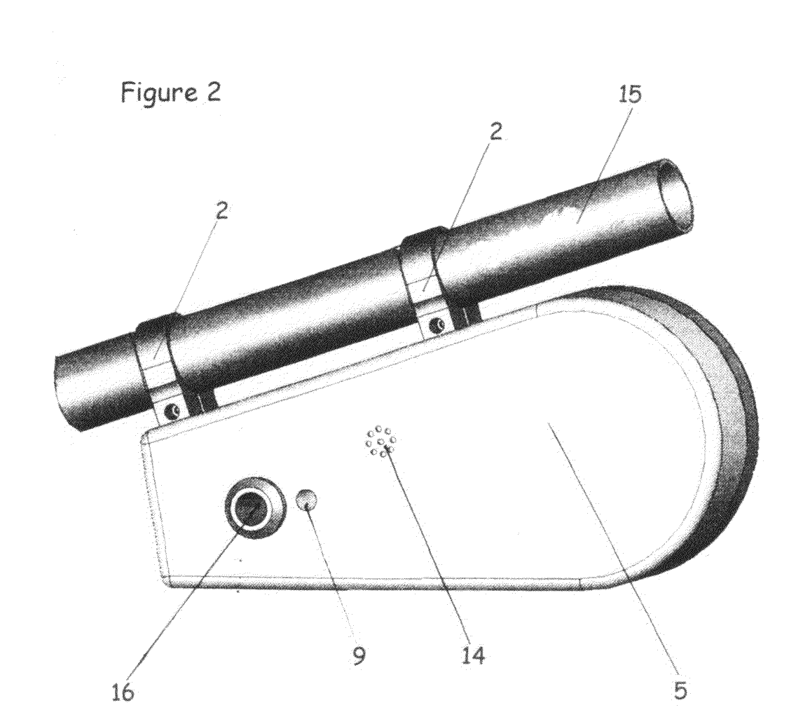

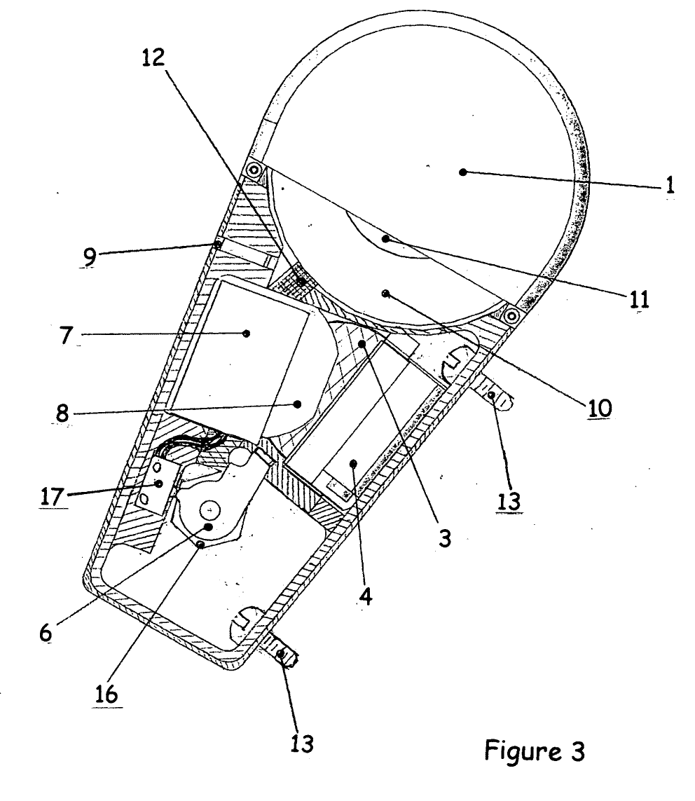

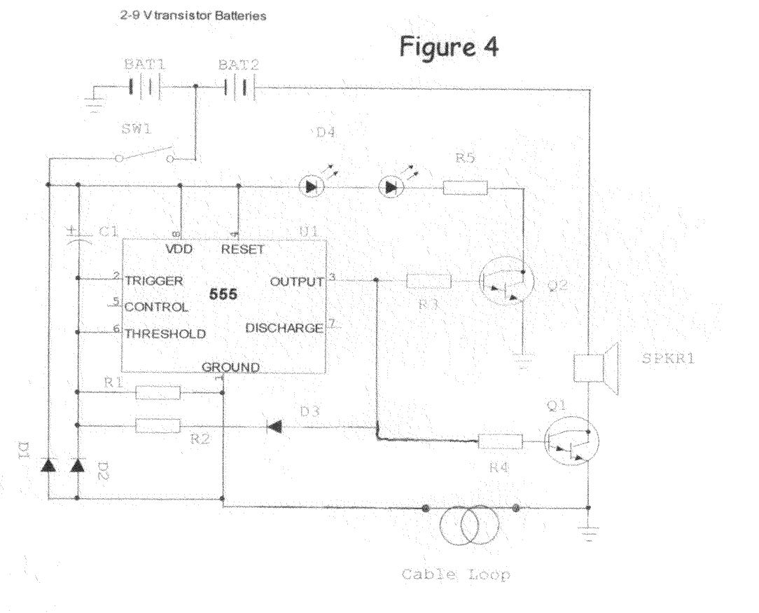

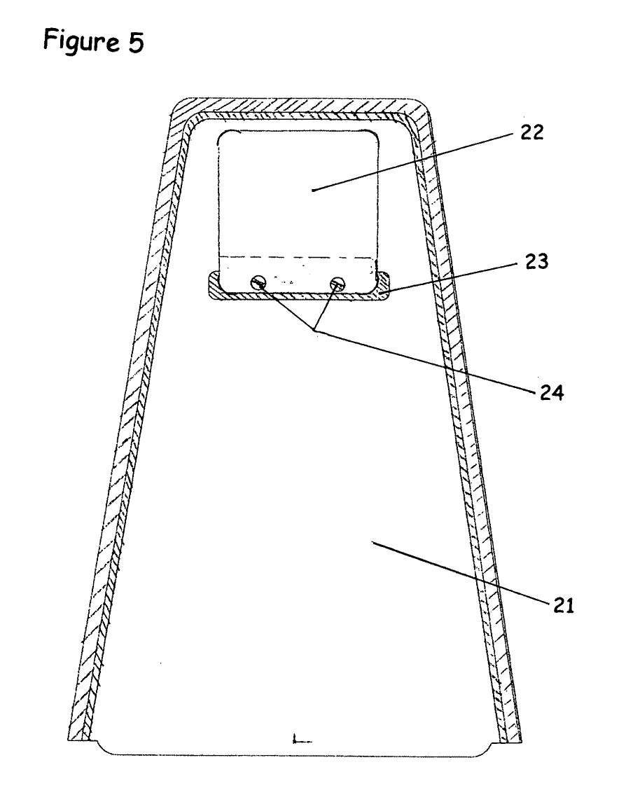

What is claimed is:

1. The device works using both mechanical and electrical modes. The unit itself is attached firmly to the bicycle or other object using clamps, security screws, or other fasteners that are accessible only from the inside of the unit. Utilizing a cable to secure tires, frame, and seat to a secure location, the locking system then activates a battery powered alarm of up to 100 DB or more that will go off continually for up to one hour making theft considerably more inconvenient for the thief.
